(19) United States
(12) Patent Application Publication
(10) Pub. No.: US 2006/0075432 A1
(43) Pub. Date: Apr. 6, 2006

(54) Method and system for providing information concerning broadcast contents for a user

(75) Inventors: Daniele Abbadessa, Heidelberg (DE); Telemaco Melia, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/241,954

(22) Filed: Oct. 4, 2005

(30) Foreign Application Priority Data
Oct. 4, 2004 (DE) 10 2004 048 552.6

(51) Int. Cl. H04N 5/445; H04N 7/10; H04N 7/025; G06F 13/00; G06F 3/00

(52) U.S. Cl. 725/46; 725/34; 725/35

(57) ABSTRACT

A method of providing information concerning broadcast contents to a user wherein the user is connected to a network—mobile radio network, Internet or the like—and is able to receive broadcasting, is characterized in—regarding the possibility of a systematical selection of broadcast contents by the user—that the user sets preferences regarding broadcast contents via the network, and that the user-specific, set preferences are combined with the sent broadcast contents by creating status lists capturing current statuses and status changes referring to the broadcast contents as set in the preferences, and that the status lists are made available to the user by a Presence server.

### BACKGROUND OF THE INVENTION

1. Field of the Invention

The present invention relates to method and system of providing information concerning broadcast contents to a user wherein the user is connected to a network—mobile radio network, Internet or the like—and is able to receive broadcasting.

2. Description of the Related Art

Methods of the mentioned kind have been known for some time in practice. In general, the network to which the user is connected, for example via laptop to the Internet or via mobile to a mobile radio network, and the broadcast network via which broadcast—TV, audio etc.—is broadcasted, are different networks. In specific cases these two networks can be identical, though, and at this point we would like to refer to the Internet radio only as an example. Here, the audio information, as for example music, news etc., is sent from a station over the Internet and can be received by a user with his PC or laptop. Together with the actual audio information, it is often the case that additional information is provided which concerns the sent broadcast contents. In this sense, it is common, for example, to display currently sent music titles or provide information regarding future program contents.

It is a problem with the aforementioned methods though, that the broadcast receiver of the user must be in a ready-to-receive status, i.e. it must be switched on in order to receive the additional information as described above. Furthermore, the additional information refers in general only to broadcast contents of the chosen channel.

In case a user is interested in specific broadcast contents, he consequently has to turn on his broadcast receiver and go through the single channels to look for corresponding contents. These high efforts for searching interesting contents are extremely time-consuming and make the usage of broadcast for a wide range of users unattractive. In addition, the continuous operation mode of the device while doing the several searches leads to an increased consumption of energy. In case of portable mobile devices with integrated broadcast receivers, such as a handset with integrated DVB-H (Digital Video Broadcasting Handheld) for example, which in general work with batteries, this is extremely critical regarding the available span of time during which the device can be used.

### SUMMARY OF THE INVENTION

Hence, the present invention is based on the task to furnish a method of providing information concerning broadcast contents to a user of the above-described kind which enables the user to select broadcast contents systematically.

According to the invention, the aforementioned problem is solved by the characteristics of claim 1. According to this, the method mentioned is designed in such a way that the user sets preferences regarding broadcast contents via the network or a separate network, that the set user-specific preferences are combined with the sent broadcast contents by creating status lists with which current statuses and status changes of the broadcast contents according to the set preferences are captured, and that the status lists are made available to the user via a Presence server.

It is an essential idea of the invention to provide a user with broadcast-related information which corresponds with his individual interests by using Presence technology. In other words, the method according to the invention enables the user to access information about broadcast contents that are relevant for him, which means that he can systematically use broadcast services. According to the invention, based on the preferences as set by the user, dynamic status lists are created with which statuses and status changes of those broadcast contents are captured that are relevant for the user. From the status lists, which are made available to the user by a Presence server, the user gets information telling him if any interesting contents, i.e. contents corresponding to his set preferences, are broadcasted. As a result, time-consuming and annoying searching of broadcast stations for relevant contents can hence be avoided efficiently, which results in an increase of attractiveness of the broadcast services. In particular, in case of battery-run devices, the method according to the invention also offers the additional advantage of reducing energy consumption because the broadcast receiver must be turned on only when it is actually needed in order to receive currently broadcasted user-specific contents.

The term “Presence technology” as used within the context of the method according to the invention, means a range of different applications and protocols making it possible to inform the user about changes of specific statuses. Just to give some examples regarding the specifications of Presence technology, the followings should be mentioned:
the IETF RFC 2778 “A Model of Presence and Instant Messaging”, M. Day, J. Rosenberg, H. Sugano;
the IETF RFC 2779 “Instant Messaging/Presence Protocol Requirements”, M. Day, S. Aggarwal, G. Mohr, J. Vincent;
the 3GPP TS 23.141 v6.6.0 “Presence Service”; and
the OMA, “The Wireless Village initiative: System Architecture Model” vl. 1, WV-020.

It should explicitly be noted that the method according to the invention does not depend on any specific Presence technology.

Using Presence technology as according to the invention is particularly advantageous, since this technology is already being used for different communication services, such as for example voice calls, instant messaging etc. For example, instant messaging is already widely used on the Internet and has started to gain more and more importance in the mobile world. In case of instant messaging, the sender of a message is informed about the status of potential receivers by Presence technology. This message can be the information that a receiver is “online” and hence ready to receive, or “offline” and thus not ready to receive a message. Other status indications such as “away” or “Please do not disturb” etc. are possible as well. Since the method according to the invention uses known technology in this sense, the method can easily be integrated into devices for users as well as into the needed infrastructure. After all, using Presence technology is also beneficial with regard to the support of an easy-to-use user interface.

Regarding broadcast technology, it should explicitly be remarked that the invention is not subject to any restrictions in that way. The method according to the invention can be implemented for all digital as well as analogue broadcast technologies where in the application for radio, TV, DAB (Digital Audio Broadcasting) and DVB (Digital Video Broadcasting) is mainly addressed.

In the framework of a concrete embodiment, it is provided that the statuses as captured by the status lists refer to the sending activity (“on air/off air”), the sent content (“news/sports/film/magazine/ . . . ”) and/or the physical broadcast channel. If necessary, further additional information can also be incorporated into the status lists. The creation of statuses, as captured by the status lists, requires knowledge of broadcast programs. This information can be provided for example directly by the broadcast service provider or by any 3^{rd} party.

In an advantageous way, it can be provided that the setting of preferences by the user is done via a specific portal. In this way, the user could access an Internet-TV portal from his laptop, for example, and select from the TV-broadcast offer as available there, contents corresponding to his interests. The preferences can either be set immediately by the choice itself or by a respective confirmation by the user.

Regarding the access of the user to the status lists, it can be provided that the user subscribes as “watcher” with the Presence server. The terminology of the Presence technology has the opposition of “watcher” and “Presentity”, wherein “watcher” refers to a client in general receiving Presence information—from the “Presentity”. It should be noted that the above described dynamically created status lists represent “Presentities” according to the terminology of the Presence technology.

Regarding a particular user-friendliness, it can be provided that the user is informed about the current statuses and/or status changes of his status lists corresponding to his set preferences after registration with the Presence server. In other words, the user is always indicated actively the broadcast contents relevant for him, for example the beginning of a broadcasting corresponding to his interests. By these means, a particularly efficient usage of broadcasting offers is possible.

The indication can be done in an advantageous way, for example with pop-up windows, blips or the like. The indication forms can be freely chosen and set by the user according to his individual taste.

In a concrete embodiment, the created status lists can each refer to a single broadcast channel. Such an implementation is beneficial if the user is not interested in specific programs or topics, but only in the contents of a specific broadcast channel.

Alternatively, the creation of one or more status lists can be envisaged with each referring to a user-specific profile. User-specific profiles can be envisaged as topic-based profiles in particular, wherein the user selects specific topic areas such as sport programs, travel reports, talk shows etc., or time-based profiles. Generating one single status list is sufficient in case of a purely time-based user profile wherein the user picks those contents that are specifically interesting to him from broadcast channels which are available for him.

The profiles can refer to one single user. In case several users are interested in identical contents, the profiles can refer in an advantageous way also to a group of users. Due to such an approach, scalability and efficiency are further improved.

In an advantageous way, for graphical visualization of status lists, so-called “Presence buddies” can be created which can be displayed to the user on a displaying device, for example on an LCD. Regarding easy-to-handle characteristics and high clarity, the Presence buddies can be added (manually or automatically) to the Presence list of the user. The Presence list can also be shown to the user on a display—for example on a window that can be activated.

In a further advantageous step it can additionally be provided that the user can activate the broadcast channel reception by clicking on corresponding Presence buddies on his Presence list. Such an “on click” tuning can be realized depending on the actually used radio technology by selecting automatically the correct sending frequency from the status list.

Regarding high flexibility, it can be provided that regional differences in broadcast contents are taken into account. To do so, the status lists (as well as the corresponding Presence buddies) can be split up into regional status lists (and Presence buddies). Under the condition that there is information about the respective location of the user available and provided that the registration profile with his service provider allows the publication of this information, the user can be associated with those regional status lists (and Presence buddies) matching his current location. The degree of regional subdivision can be adjusted depending on the regional broadcast offer, depending on individual wishes of the user and/or depending on the availability of appropriate information about the location of the user.

There are several ways of how to design and further develop the teaching of the present invention in an advantageous way. For this purpose, it is to be referred to the patent claims subordinate to patent claim 1 on the one hand, and to the following explanation of preferred examples of an embodiment of the invention illustrated by the figure on the other hand. In connection with the explanation of the preferred examples of an embodiment of the invention with the aid of the figure, generally preferred embodiments and further developments of the teaching will be explained.

### BRIEF DESCRIPTION OF THE DRAWINGS

FIG. 1 shows in a schematic model a first example of an embodiment of the method according to the invention of providing information regarding broadcast contents to a user;

FIG. 2 shows in a schematic model a second example of an embodiment of the method according to the invention which allows the user to select specific topics;

FIG. 3 shows in a schematic overview diagram an implementation of the example of an embodiment according to FIG. 2;

FIG. 4 shows in an schematic overview the process of setting user-specific preferences; and

FIG. 5 shows in a schematic overview the created status lists corresponding to the user-specific preferences according to FIG.4.

### DESCRIPTION OF THE PREFERRED EMBODIMENTS

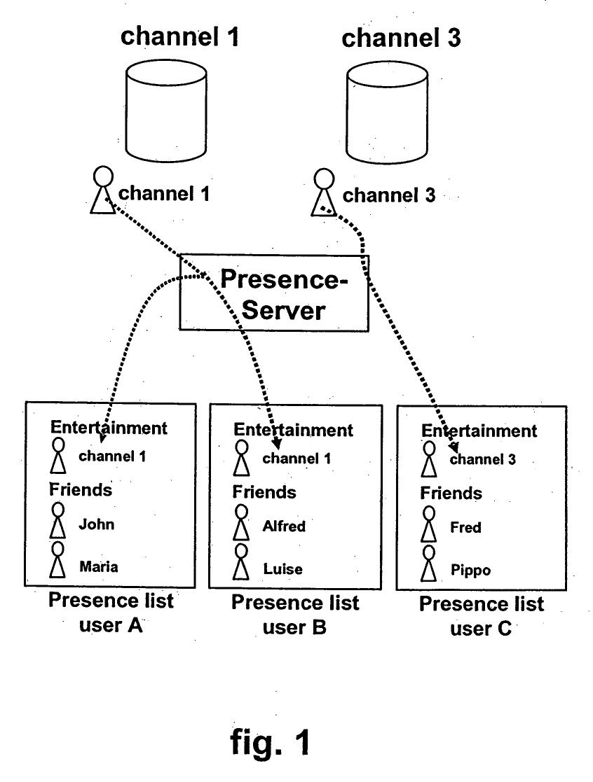

As shown in FIG. 1, users—user A, B and C—are provided information about broadcast contents corresponding to their respective preferences. The model shown reflects an approach in which the users are not interested in specific programs or contents. Instead, the users' interest focuses only on one or several broadcast channels which they have selected, for example via a corresponding portal. From the user-side, a handheld (PDA, mobile etc.) with integrated DVB-H (Digital Video Broadcasting-Handheld) receiver, for example, can serve for the selection of the broadcast channels, as well as for the actual broadcast reception.

For every broadcast channel a status list is created which is each represented by a corresponding Presence buddy. This is shown exemplarily in FIG. 1 for two channels—channel 1 and channel 3. In the status lists, statuses and status changes corresponding to the specific broadcast channel are captured. This information is transmitted to a Presence server and updated there at regular intervals. The Presence server and its associated services can be provided, for example, by a broadcast service provider himself or by any other service provider.

After the user has set his preferences, corresponding Presence buddies are added automatically to a Presence list of the user. In the example of an embodiment given, the Presence lists of user A and user B comprise the Presence buddies associated with channel 1, whereas in the Presence list of user C the Presence buddy associated with channel 3 is comprised.

Along the lines of the already known approach of Presence technology, wherein for example user A is informed on the basis of his Presence list about the receiving status (“online/offline”) of his friends John and Maria, user A is provided with information about the Presence status of the Presence buddy associated with channel 1 and incorporated in his Presence list. This Presence status changes according to the broadcast contents sent on channel 1. The same is valid for the users B and C under the condition that the information for user C—according to the preferences as set by him—do not refer to channel 1, but to channel 3.

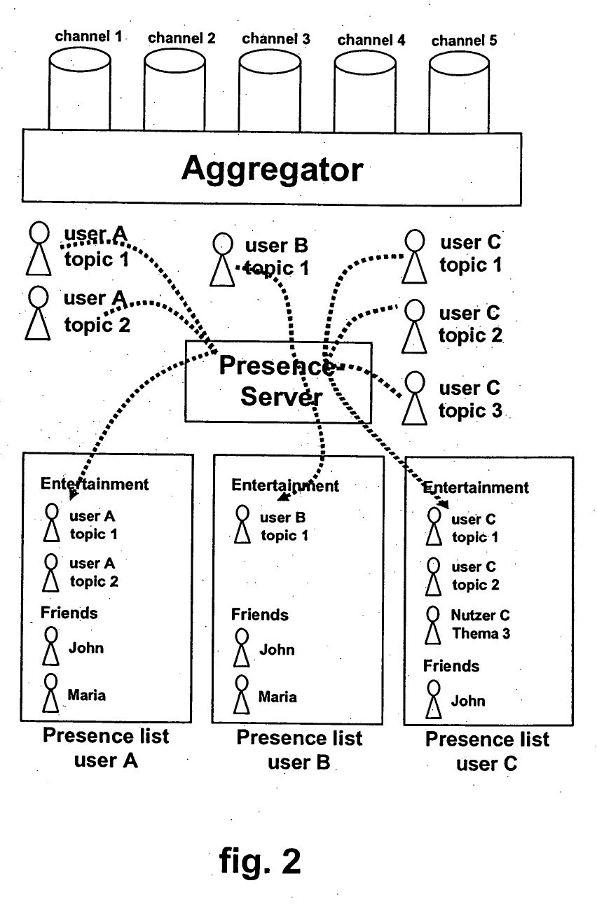

FIG. 2 also shows a schematic model of an embodiment of an example of the method according to the invention. The implementation is more complex than in the embodiment of an example given above and it allows the user to set specific topic areas as preferences. In this way, user A has selected topics 1 and 2, whereas user B has selected exclusively topic 1 and user C has selected topics 1, 2 and 3. For each combination of user/topic, a status list, i.e. a Presentity, is created by which—as already described in the context of FIG. 1—statuses and status changes referring to the respective user preferences are captured. This Presence information is always updated and delivered to a Presence server. The Presence buddies (i.e. watchers) associated with the status lists are added to the Presence lists of the single users respectively.

In the case that several user preferences match each other, status lists can be grouped together. Consequently, the Presence buddies of several users can be “watchers” of the same Presentity. This results in a more flexible and scalable system.

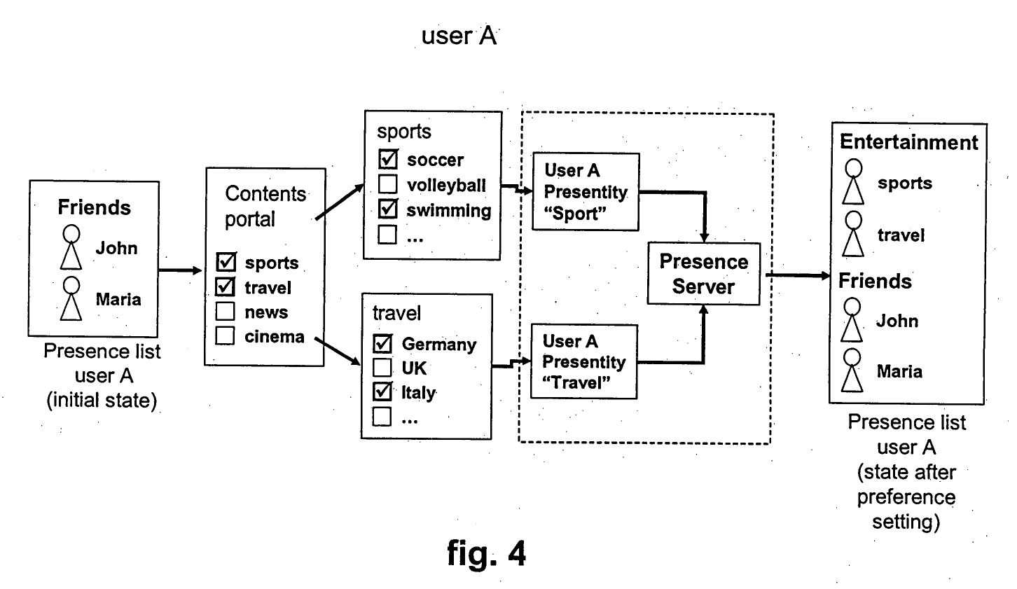

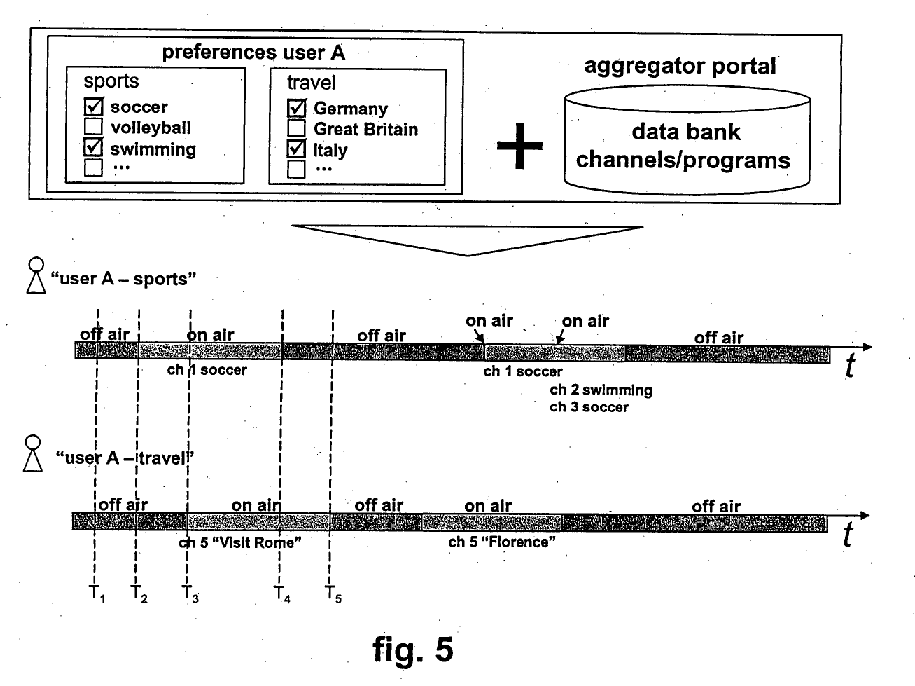

The degree of granularity with which the topics can be selected, can be chosen freely. From the user side, for example, the topic “travel reports” can be picked on a more specified level as “travel reports Europe” and on an even more specified level as “travel reports about Italian cities” and so on (see for example FIG. 4). In the scenario shown in FIG. 2, the user's preferences and the information about the contents of the available broadcast channels—here channel 1 to 5—are combined by an aggregator in order to create the Presence status lists and the corresponding Presence buddies (see for example FIG. 5).

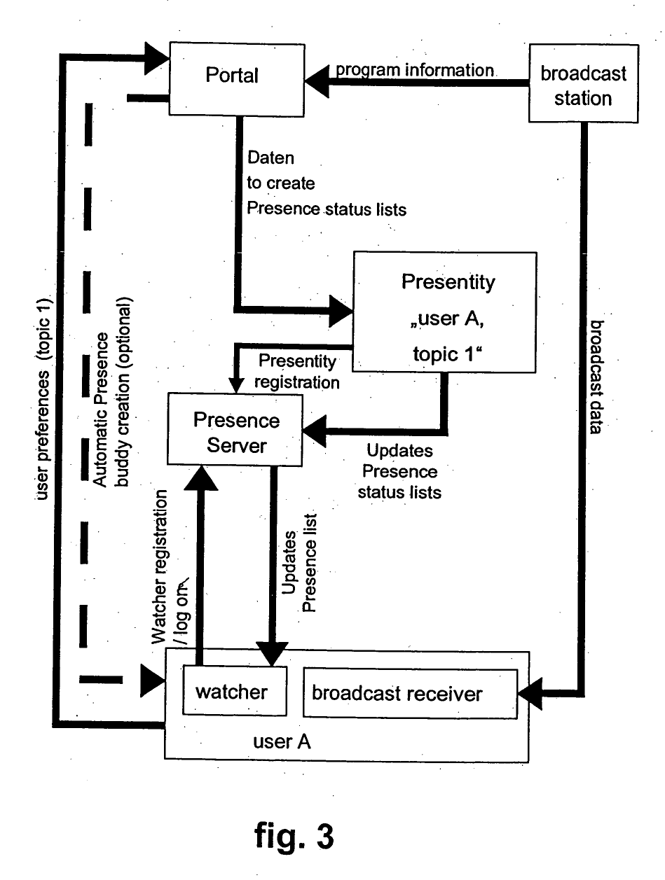

FIG. 3 shows in a schematic diagram the single logical modules and data flows of an implementation according to the example of an embodiment as shown in FIG. 2. User A, who can receive data—audio, video or other data—broadcasted via a broadcasting station or a broadcasting radio network with a broadcast receiver, first defines his broadcast-related preferences (here: topic 1) via a portal. The portal has access to information about broadcast contents broadcasted by different stations/channels. On the basis of the user preferences on the one hand, and the program information on the other hand, dynamic Presence status lists are created which are also called “Presentities” in the terminology of Presence technology. In the concretely given example, a Presentity “User A, topic 1” is created. The statuses and status changes captured by this Presence status list are transmitted to a Presence server.

For the preferences as set by user A, i.e. in this case for topic 1, a Presence buddy representing the corresponding Presence status list (Presentity “user 1, topic 1”) is created. This Presence buddy is subscribed with the Presence server and added (automatically or manually) to a Presence list of user A. This means that this Presence buddy is subscribed as a “watcher” with the Presence server. After having logged in, user A is transmitted messages by which he is informed about statuses and status changes captured by the Presentity “user A, topic 1”. This information can be shown to user A, for example in his Presence list on the display of his laptop or his mobile. Logging on of the user can be performed automatically as well.

FIG. 4 illustrates the selection process and the setting of user-specific preferences with the example of user A. On the left side of FIG. 4, the Presence list of user A is shown in its initial state. The Presence list comprises in the group “friends” two Presence buddies, wherein the first Presence buddy refers to John, and the second one to Maria. This selection effects that user A can be informed about the Presence statuses (for example “online”, “offline”, “away”, “in a meeting” etc.) of John and Maria. This is the conventional usage of Presence technology as it is known in case of instant messaging, for example.

In a first step, user A selects via a content-portal from the topics available and offered by the broadcast service provider, such topics that correspond to his interests. In the given example, those are the topics “sports” and “travel”. In a next step user A specifies his interests in that way that he selects in the area of “sports” the topics “volleyball” and “swimming”, and in the area of “travel” the topics “Germany” and “Italy”. As mentioned before, the degree of granularity with which the topics can be selected, is freely scalable.

After the selection is made and—if necessary—after a confirmation by the user for the selection made, the corresponding Presence buddies are created and added to the Presence list of user A. This is why now there is an additional group added to Presence list, which is the group “entertainment” in which a Presence buddy representing the preference “sports”, as well as a Presence buddy representing the preference “travel” are added.

FIG. 5 shows schematically an overview of the status lists as created according to the user-specific preferences as given in FIG. 4. The creation of status lists is performed on the basis of the preferences set by user A as well as on the basis of the program information of the single channels/stations that are provided by an aggregator portal. Corresponding to the illustrated example of an embodiment, all in all there are two status lists shown, i.e. one status list “user A—sports” and one status list “user A—travel”.

In the moment T₁, both status lists show the status “off air”. User A, to whom this information is shown in his Presence list, hence knows that currently no broadcast contents that might interest him are broadcasted. In the moment T₂, a soccer report starts on channel 1. The state in the status list “user A—sports” changes from “off air” to “on air”. User A is informed about this status change for example by a pop-up window or a blip and in his Presence list there can be displayed a corresponding indication for such a report. It can be provided that user A can then activate his broadcast receiver by simply clicking on the corresponding Presence buddy “user A—sports” and that the correct channel (here: channel 1) is selected automatically.

At the moment T₃, in the second status list (“user A—travel”) the state also changes from“off air” to “on air” because a report corresponding to the preferences as set by user A is about to start (“Visit Rome” on channel 5). A corresponding indication is also shown in the Presence list of user A. The next status change, about which user A is informed, happens at moment T₄. At this moment the soccer report ends on channel 1 and the state in the status list “user A—sports” changes from “on air” to “off air”. The same happens to the status list “user A—travel” in moment T₅.

Finally, it is particularly pointed out that the arbitrarily chosen examples of an embodiment as described above only serve as an illustration of the teaching as according to the invention, but that they do by no means restrict the latter to the given examples of an embodiment.

1. A method of providing information concerning broadcast contents to a user, wherein the user is connected to a network and is able to receive broadcasting, the method comprising:
the user setting preferences regarding broadcast contents via the network or a separate network;
combining the user-specific, set preferences with the sent broadcast contents by creating status lists capturing current statuses and status changes referring to the broadcast contents as set in the preferences;
making the status lists available to the user by a Presence server.

2. The method according to claim 1, wherein the statuses as captured by the status lists refer to the sending activity, the sent content, and/or the physical sending channel and/or additional information.

3. The method according to claim 1, wherein the user sets his preferences via a specific portal.

4. The method according to claim 1, wherein the user logs on to a Presence server as a watcher.

5. The method according to claim 4, wherein the user is informed after having logged on to the Presence server about current statuses and/or status changes of the status lists corresponding to his set preferences.

6. The method according to claim 1, wherein the user's attention is drawn to status changes by pop-up windows, blips or the like.

7. The method according to claim 4, wherein the user's attention is drawn to status changes by pop-up windows, blips or the like.

8. The method according to claim 1, wherein the created status lists refer each to a single broadcast channel.

9. The method according to claim 4, wherein the created status lists refer each to a single broadcast channel.

10. The method according to claim 1, wherein the created status lists each refer to a user-specific profile.

11. The method according to claim 4, wherein the created status lists each refer to a user-specific profile.

12. The method according to claim 10, wherein the user-specific profile is based on topics or time.

13. The method according to claim 10, wherein the profile refers to a single user or a group of users.

14. The method according to claim 1, wherein Presence buddies representing the status lists are created in order to visualize the latter graphically.

15. The method according to claim 4, wherein Presence buddies representing the status lists are created in order to visualize the latter graphically.

16. The method according to claim 10, wherein Presence buddies representing the status lists are created in order to visualize the latter graphically.

17. The method according to claim 14, wherein the Presence buddies are added to a Presence list of the user.

18. The method according to claim 14, wherein the user can activate the reception of broadcast contents corresponding to his preferences by clicking on Presence buddies in his Presence list.

19. The method according to claim 1, wherein regional differences of broadcast contents are taken into consideration by splitting up the status lists created on the basis of set preferences into regional status lists and the user being associated with the corresponding regional status lists due to his current location.

20. The method according to claim 4, wherein regional differences of broadcast contents are taken into consideration by splitting up the status lists created on the basis of set preferences into regional status lists and the user being associated with the corresponding regional status lists due to his current location.

21. The method according to claim 10, wherein regional differences of broadcast contents are taken into consideration by splitting up the status lists created on the basis of set preferences into regional status lists and the user being associated with the corresponding regional status lists due to his current location.

22. The method according to claim 14, wherein regional differences of broadcast contents are taken into consideration by splitting up the status lists created on the basis of set preferences into regional status lists and the user being associated with the corresponding regional status lists due to his current location.

23. The method according to claim 19, wherein the degree of regional differentiation is adjustable.

24. The method according to claim 1, wherein each of the network and the separate network is a mobile radio network, a broadcast network and/or the Internet.

25. A system for providing information concerning broadcast contents to a user, wherein the user is connected to a network and is able to receive broadcasting, the system comprising:
a user interface for the user setting preferences regarding broadcast contents via the network or a separate network;
a status list generator for combining the user-specific, set preferences with the sent broadcast contents to create status lists capturing current statuses and status changes referring to the broadcast contents as set in the preferences; and
a server for making the status lists available to the user.
